(19) United States
(12) Patent Application Publication
(10) Pub. No.: US 2015/0338816 A1
(43) Pub. Date: Nov. 26, 2015

(54) IMAGE FORMING APPARATUS

(71) Applicant: CANON KABUSHIKI KAISHA, Tokyo (JP)

(72) Inventor: Takuma Tadomi, Toride-shi (JP)

(21) Appl. No.: 14/717,394

(22) Filed: May 20, 2015

(30) Foreign Application Priority Data
May 21, 2014 (JP) 2014-105181

(51) Int. Cl. G03G 15/00; G03G 15/20

(52) U.S. Cl. CPC G03G 15/70; G03G 15/2017

(57) ABSTRACT

An image forming apparatus includes: an image forming portion; a pair of rotatable members, at least one of which is an endless belt; a contact-and-separation portion; a driving portion; a detecting portion configured to detect presence or absence of the sheet and another object on a sheet feeding path downstream of a fixing nip with respect to a sheet feeding direction; and an output portion configured to output a signal indicating breakage of the belt upon detection of the presence of the object on the sheet feeding path by the detecting portion when said rotatable members are spaced from each other and the belt rotates.

### FIELD OF THE INVENTION AND RELATED ART

The present invention relates to and image forming apparatus such as a copying machine, a printer, a facsimile machine and a multi-function machine having functions of these machines.

In a conventional image forming apparatus, a fixing device for fixing a toner image (image), formed on a sheet, on the sheet is provided. In the fixing device disclosed in Japanese Laid-Open Patent Application (JP-A) 2005-316062, the sheet is nipped and fed using a heating roller and a press-contact belt supported by a roller, so that the toner image is formed on the sheet.

Further, JP-A 2005-316062 discloses an image forming apparatus having a constitution in which when the sheet jams at an intermediate portion of a feeding path, generation of the jam is detected. This image forming apparatus is also provided with a sensor for detecting whether or not the sheet is present on the feeding path in a side downstream of the fixing device with respect to a sheet feeding direction. The image forming apparatus discriminates whether or not the jam generates, on the basis of an output of the sensor.

The image forming apparatus is further provided with a screen, and information is displayed on the screen, so that various types of notification can be provided. The image forming apparatus including such a screen is capable of notifying an operator of prompting of jam clearance when the jam generates.

A belt used in such a fixing device is designed to have sufficient strength so as to withstand long-term use, but in the case where an unexpected external force is exerted on the belt during the jam clearance or the like, there is a liability that the surface of the belt is damaged. In the case where the surface of the belt is damaged, it is desirable that the belt is exchanged early, but if the damaged belt is used continuously without being exchanged, there is a liability that the damage develops into breakage of the belt. In the worst case, there is a liability that a part or all of the belt disconnects from a roller supporting the belt.

For that reason, in the image forming apparatus, in the case where the breakage of the belt used for the fixing device generated, it is desirable that the breakage is detected.

### SUMMARY OF THE INVENTION

A principal object of the present invention is to provide an image forming apparatus capable of detecting breakage of a belt used in a fixing device.

According to an aspect of the present invention, there is provided an image forming apparatus comprising: an image forming portion configured to form a toner image on a sheet; a pair of rotatable members configured to form a fixing nip for fixing the toner image, formed by the image forming potion, on the sheet, at least one of the pair of rotatable members being an endless belt; a contact-and-separation portion configured to move the pair of rotatable members toward and away from each other; a driving portion configured to rotationally drive the belt; a detecting portion configured to detect presence or absence of the sheet and another object on a sheet feeding path downstream of the fixing nip with respect to a sheet feeding direction; and an output portion configured to output a signal indicating breakage of the belt upon detection of the presence of the object on the sheet feeding path by the detecting portion when the rotatable members are spaced from each other and the belt rotates.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration showing a structure of an image forming apparatus in Embodiment 1.

FIG. 2 is an illustration of a fixing device in cross section (in a pressed state) in Embodiment 1.

FIG. 3 is a perspective view of the fixing device.

FIG. 4 is a side view of the fixing device.

FIG. 5 is an illustration of the fixing device in cross section (in a spaced state).

FIG. 6 is a flowchart for illustrating a fixing nip forming operation and a block diagram of a constitution relating to the fixing nip forming operation in Embodiment 1.

FIG. 7 is a flowchart for illustrating a belt breakage detecting operation in Embodiment 1.

FIG. 8 is a block diagram of a constitution relating to the belt breakage detection in Embodiment 1.

FIG. 9 is a flowchart for illustrating a belt breakage detecting operation in a conventional example.

### DESCRIPTION OF THE EMBODIMENTS

### Embodiment 1

### Image Forming Apparatus

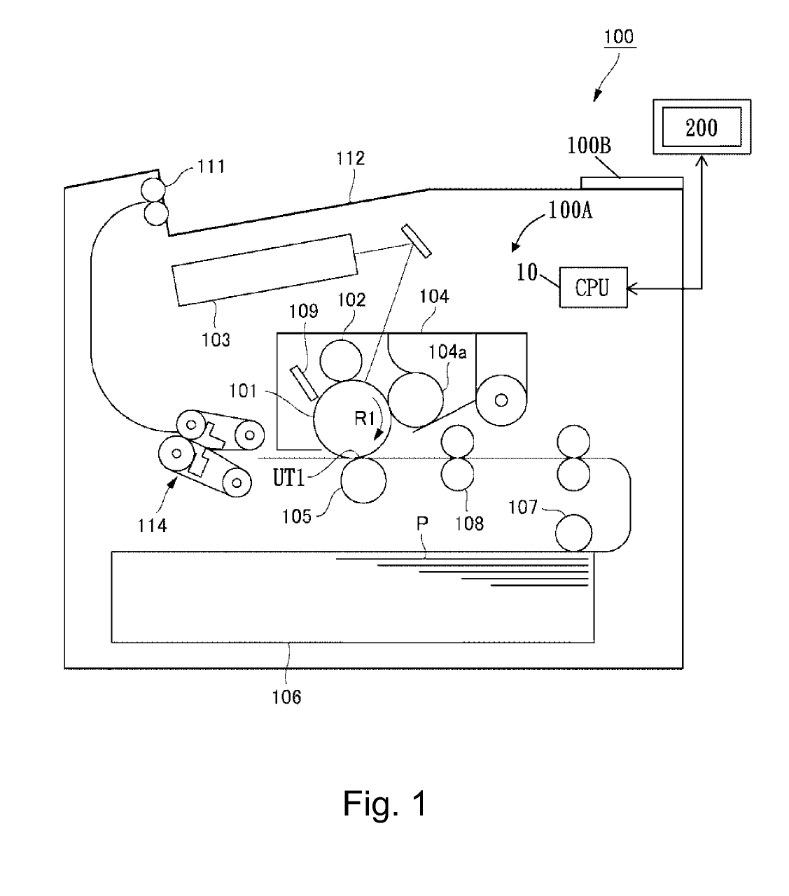

FIG. 1 is a schematic view of an image forming apparatus 100 in this embodiment. In this embodiment, description will be made using an electrophotographic laser beam printer as the image forming apparatus 100. The image forming apparatus 100 is capable of outputting an image-formed product on which a toner image corresponding to image information. The image information is inputted from a host device 200, such as a personal computer (PC) connected with a control circuit (CPU) 10 through, e.g., network, into the control circuit 10.

Inside the image forming apparatus 100, an image forming portion 100A for forming the toner image on a sheet (recording medium, recording material, paper) P and a fixing device 114 for fixing the toner image formed on the sheet P are provided.

The image forming portion 100A includes a photosensitive drum 101 and includes, at a periphery of the photosensitive drum 101, a charging roller 102, an exposure device 103, a developing device 104, a transfer roller 105 and a drum cleaning device 109.

These members are disposed for performing an electrophotographic image forming process on the photosensitive drum 1. The photosensitive drum 101 is an electrophotographic photosensitive member prepared by forming a photosensitive material such as an OPC or amorphous silicon on a cylinder-like substrate of aluminum or the like, and rotates in an arrow R1 direction (FIG. 1) at a predetermined process speed.

The charging roller 102 electrically charges an outer peripheral surface of the photosensitive drum 101 to a uniform potential. The exposure device 103 forms an electrostatic image for an image on the surface of the photosensitive drum 101 by scanning the photosensitive drum surface with a laser beam subjected to ON-OFF modulation depending on an image signal based on image information. The developing device 104 carries a one-component developer on a developing sleeve 104a and develops the electrostatic image on the photosensitive drum 101 into an unfixed toner image. The transfer roller 105 is press-contacted to the photosensitive drum 101 to form a transfer nip UT1.

A sheet P taken out from a cassette 106 by a sheet feeding roller 107 is fed to the transfer nip UT1 from a registration roller pair 108 in synchronism with the toner image on the photosensitive drum 101. At the transferring nip UT1, by the transfer roller 105 to which a voltage (transfer bias) is applied, the unfixed toner image carried on the photosensitive drum 101 is transferred onto the sheet P. The sheet P discharged from the transfer nip UT1 is fed to the fixing device 114.

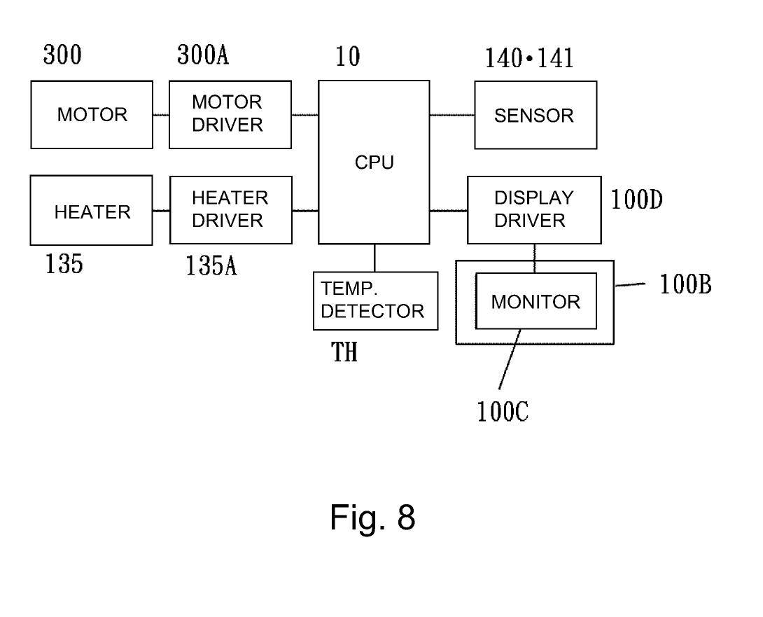

The fixing device 114 heats and presses, while nip-feeding the sheet P through a fixing nip, the sheet P on which the unfixed toner image is carried, thus fixing the toner image as a fixed image on the sheet P. The sheet P on which the image is fixed is discharged and stacked on a sheet discharge tray 112 positioned at an upper portion of the printer by a sheet discharging roller 111. An operating panel (operating portion) 100B includes an information inputting means for inputting various pieces of information of the printer 100 into the control circuit (CPU) 10 and an information display portion (monitor) 100C (FIG. 8) and the like.

### <Fixing Device>

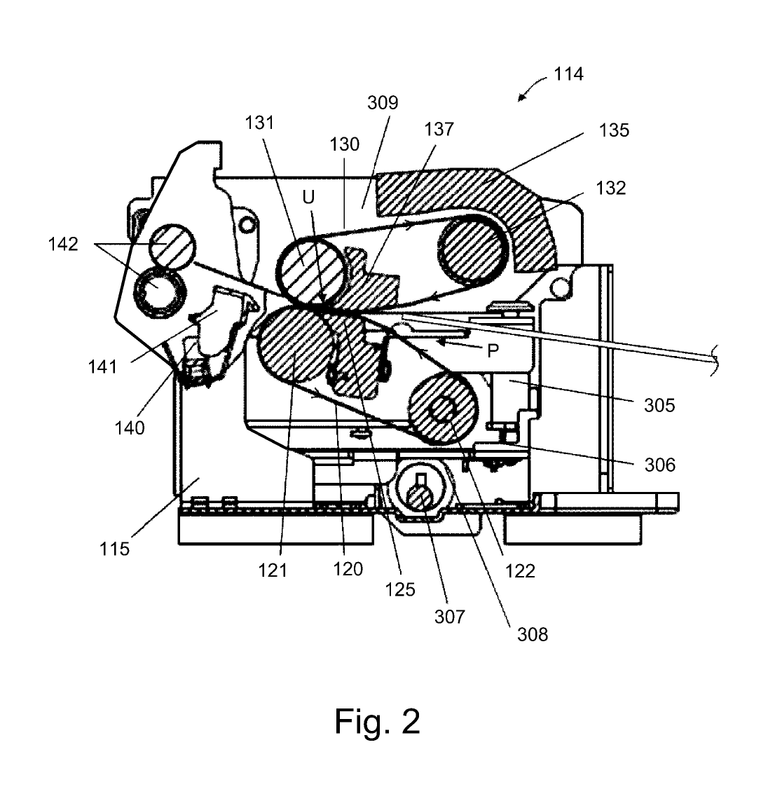

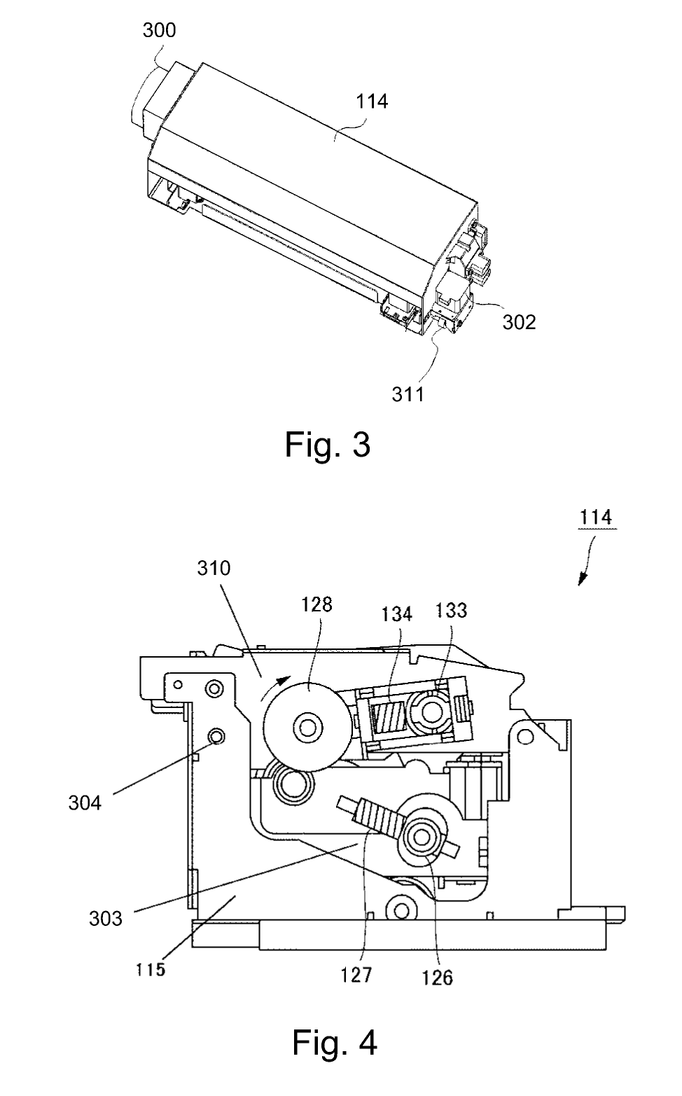

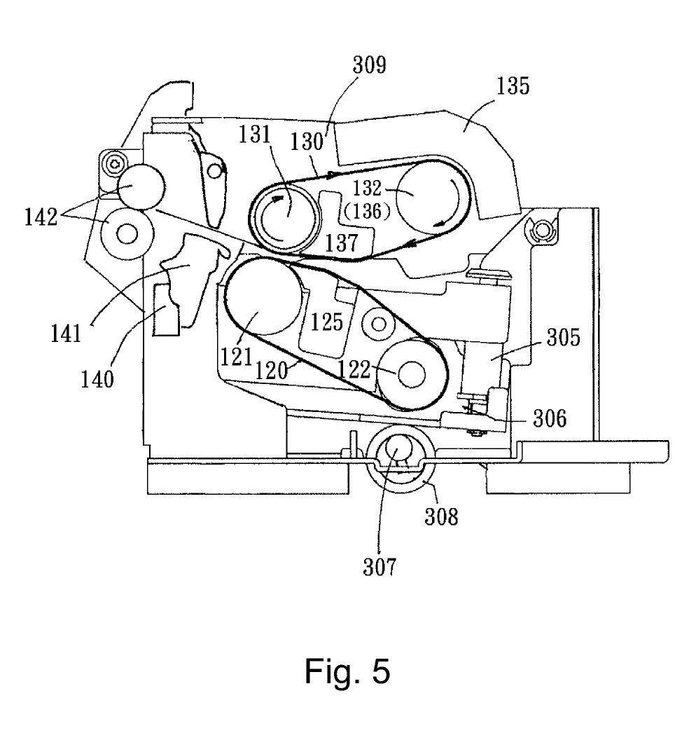

The fixing device 114 will be described in detail. In this embodiment, the fixing device 114 is of an electromagnetic induction heating belt type and of an oil-less fixing type. FIGS. 2 and 5 are sectional views of the fixing device, FIG. 3 is a perspective view of the fixing device, and FIG. 4 is an illustration of a driving system of the fixing device.

The fixing device 114 forms a fixing nip U by causing a pressing belt 120 assembled with an upper frame 309 to be press-contacted to a heating belt (first rotatable member: rotatable heating member or rotatable fixing member) 130 assembled with a lower frame 306.

A fixing frame 115 is fixed detachably mountable to a main assembly of the image forming apparatus. The lower frame 306 is swingably supported by the fixing frame 115, and is swung by driving a pressing cam 308. When the lower frame 306 is swung by the pressing cam 308, the pressing belt 120 is contacted to and separated from the heating belt 130.

The heating belt 130 is extended around a plurality of rollers, shaft-supported by the fixing frame 115, i.e., a driving roller 131 and a tension roller 132 under application of predetermined tension (e.g., 200N) and can be rotated and circulated. As the heating belt 130, e.g., a belt prepared by coating a 300 μm-thick silicone rubber on a magnetic metal layer, such as nickel layer or a stain less steel layer, of 75 μm in thickness, 380 mm in width and 200 mm in circumference and then by coating the metal layer with a PFA tube as a surface layer may be used. The heating belt 130 is not limited to this belt but may appropriately be selected from members if the selected member generates heat through electromagnetic induction heating by an exciting coil 135 and has a heat-resistant property.

The heating belt 130 is fed by rotation of the driving roller 131. In order to stably feed the sheet P at the fixing nip U, a driving force is transmitted with reliability between the heating belt 130 and the driving roller 131.

The driving roller 131 has a function of supporting an inner surface of the heating belt 130 to generate pressure at the fixing nip U. The driving roller 131 is a roller, of the rollers supporting the heating belt 130, disposed in a downstream side (exit side) of the fixing nip with respect to the sheet feeding direction. When a pressing roller 121 is press-contacted to the driving roller 131, an elastic layer of the driving roller 131 is elastically deformed in a predetermined amount. The driving roller 131 in this embodiment is a roller prepared by forming, through integral molding, an elastic layer of a heat-resistant silicone rubber as a surface layer of a solid core metal formed of stainless steel in an outer diameter of 18 mm.

The tension roller 132 has a function of effecting lateral deviation (shift) control of the heating belt 130 by being raised and lowered at its one end with respect to a longitudinal direction (rotational axis direction) to be inclined and moved and a function of imparting a belt tension to the heating belt 130. The tension roller 132 in this embodiment is a hollow roller formed of stainless steel to have an outer diameter of about 20 mm and an inner diameter of about 18 mm, and functions as a belt stretching roller.

The heating belt 130 is, with its rotation, laterally shifted toward an (one) end of the tension roller 132 with respect to a rotational axis direction and therefore in this embodiment, the tension roller 132 is tiled by an unshown steering mechanism to control the lateral movement of the heating belt 130.

Inside the heating belt 130, at a position corresponding to an entrance side (at a position upstream of the driving roller 131 with respect to the sheet feeding direction) of the fixing nip region, a pad stay 137 formed of stainless steel (SUS material) is provided. The pad stay 137 is pressed toward a pressing pad 125 under a predetermined pressure of 400N, thus forming the fixing nip U together with the driving roller 131.

The pressing belt 120 is extended around pressing roller 121 and a tension roller 122 which are shaft-supported by the lower frame 306 under application of predetermined tension (e.g., 200N) and can be rotated and circulated. As the pressing belt 120 in this embodiment, a belt prepared by coating, e.g., a 300 μm-thick silicone rubber on a nickel layer of 50 μm in thickness, 380 mm in width and 200 mm in circumference and then by coating the metal layer with a PFA tube as a surface layer may be used. The pressing belt 120 is not limited to this belt but may appropriately be selected from members if the selected member has a heat-resistant property.

The pressing roller 121 in this embodiment is a solid roller, formed of stainless steel to have an outer diameter of 20 mm, and supports the pressing belt 120 from an inside in the exit side of the fixing nip region.

The tension roller 122 has a function of effecting lateral deviation (shift) control of the pressing belt 120 by being raised and lowered at its one end to be inclined and moved and a function of imparting a tension to the pressing belt 120. The tension roller 122 in this embodiment is a hollow roller formed of stainless steel to have an outer diameter of about 20 mm and an inner diameter of about 18 mm, and functions as a belt stretching roller.

The heating belt 120 is, with its rotation, laterally shifted toward an (one) end of the tension roller 122 with respect to a rotational axis direction and therefore in this embodiment, the tension roller 122 is tiled by an unshown steering mechanism to control the lateral movement of the pressing belt 120.

Inside the pressing belt 120, at a position corresponding to an entrance side (upstream side of the pressing roller 121 with respect to the sheet feeding direction) of the fixing nip region between the pressing belt 120 and the heating belt 130, the pressing pad 125 formed of silicone rubber is provided. The pressing pad 125 in this embodiment is pressed against the pressing belt 120 under a predetermined pressure of 400N, thus forming the fixing nip U together with the pressing roller 121.

As shown in FIG. 4, the tension roller 132 in this embodiment is supported by a bearing 133 at each of its end portions, and imparts a tension of 200N (20 kgf) to the heating belt 130 by a tension spring 134. The tension roller 122 is supported by a bearing 126 at each of its end portions, and imparts a tension of 200N (20 kgf) to the pressing belt 120 by a tension spring 127.

By a driving motor as a driving portion, a driving force is externally inputted into a gear 128. The gear 128 is connected to a shaft end of the driving roller 131. The driving roller 131 and the pressing roller 121 are connected by an unshown gear train provided in an opposite side to the gear 128, and therefore are rotated in interrelation with each other.

The upper frame 309 rotatably supports the driving roller 131 and includes an upper plate 310 for holding an end portion of the pad stay 137. The lower frame 306 rotatably supports the pressing roller 121 and includes a lower plate 303 for holding an end portion of the pressing pad 125. The lower frame 306 is rotatably supported by a hinge shaft 304 provided on the lower plate 303.

When the lower frame 306 rotates about the hinge shaft 304 in a direction approaching the upper frame 309, in the upstream side of the fixing nip region, the pad stay 137 and the pressing pad 125 are pressed toward each other via the fixing belt 105 and the pressing belt 120, and in the downstream side of the fixing nip region, the driving roller 131 and the pressing roller 121 are pressed toward each other via the fixing belt 105 and the pressing belt 120. In this embodiment, a pressing force between the lower frame 306 and the upper frame 309 is set at a predetermined pressure (e.g., 400N) by the pressing spring 305, and the fixing nip U is formed by the pressing force. The lower frame 306 is constituted so as to movable between a pressing position (FIG. 2) and a spaced position (FIG. 5) by rotation of a pressing cam 308 provided at each of end portions of a pressing cam shaft 307. The pressing cam shaft 307 is rotated by driving a pressing motor 302 (FIG. 3) to operate a pressing gear 311.

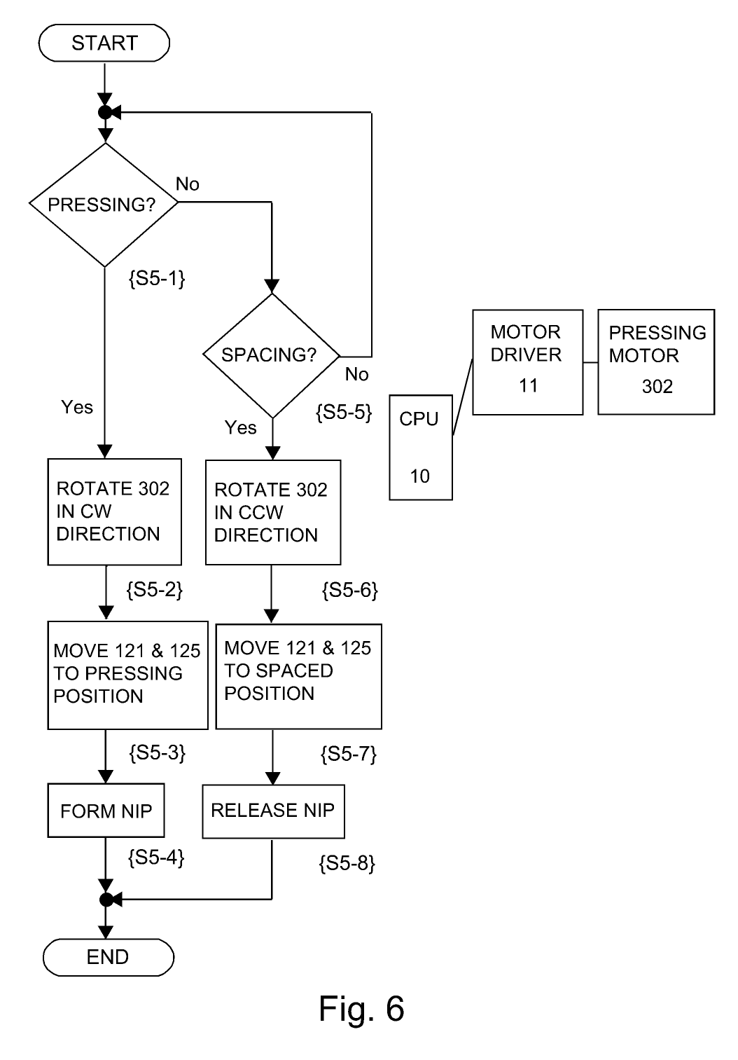

A forming operation of the fixing nip U by movement of the pressing roller 121 and the pressing pad 125 will be described using a flowchart and a block diagram shown in FIG. 6.

When a pressing instruction is made by the CPU 10 <S5-1>, a motor driver 11 rotates the pressing motor 302 in the clockwise (CW) direction in a predetermined number (N) of rotation <S5-2>. When the pressing cam shaft 307 is rotated by the pressing gear 311, the pressing pad 125 and the pressing roller 121 which are supported by the lower frame 306 are moved to a pressing position <S5-3>. In this embodiment, a group of constituent elements including the pressing motor 302, the hinge shaft 304, the pressing spring 305, the lower frame 306, the pressing cam shaft 307, the pressing cam 308, the upper frame 309 and the pressing gear 311 is referred to as a contact-and-separation portion for moving the heating belt 130 and the pressing belt 120 toward and away from each other.

By the movement of the pressing pad 125 and the pressing roller 121 to the pressing position <S5-3>, the fixing belt 105 and the pressing belt 120 are press-contacted to each other, so that the fixing nip U is formed as shown in FIG. 2 <S5-4>.

Similarly, when a spacing instruction is made by the CPU 10 <S5-5>, the pressing motor 302 rotates in the counterclockwise (CCW) direction in a predetermined number (R) of rotation <S5-6>. As a result, the pressing pad 125 and the pressing roller 121 which are supported by the lower frame 306 are moved to a spaced position <S5-7>, so that the fixing nip U is released (eliminated) <S5-8>.

In a side downstream of the fixing nip U with respect to the sheet feeding direction, a detecting sensor 140 and a sensor flag 141 urged by an unshown spring which are used as a detecting portion for detecting the presence or absence of the sheet P are provided. The sensor flag 141 in this embodiment is disposed over the entire longitudinal region of the fixing nip U.

The sensor flag 141 and the detecting sensor 140 detects the presence or absence of the sheet P in the side downstream of the fixing nip U with respect to the sheet feeding direction, and are principally used for detecting generation of a jam at the fixing nip U. For example, in the case where the sensor flag 141 is urged by the fed sheet P and the detecting sensor 140 reacts thereto for a predetermined time or more, the CPU 10 discriminates that the jam generates.

In this embodiment, during the feeding of the sheet P, in the case where the detecting sensor 140 reacts to the urging of the sensor flag 141 in a time which is 10% or more longer than an ordinary time required for the passing of the sheet P through the detecting sensor 140, the CPU 10 discriminates that the jam generates. Then, the CPU 10 notifies a monitor 100C of the generation of the jam by controlling a display driver 100D. Specifically, at a sheet feeding speed of 300 mm/sec, in the case where a short direction of an A4-sized sheet is the sheet feeding direction, when the detecting sensor 140 continuously reacts to the urging of the sensor flag for 0.77 sec or more, the CPU 10 notifies the monitor 100C of the jam generation.

The detecting sensor 140 detects the presence or absence of the sheet P when the sensor flag 141 is urged. For that reason, if an object urges the sensor flag 141, the detecting sensor 140 can detect the object other than the sheet P. The detecting sensor 140 and the sensor flag 141 are provided in the side downstream of the fixing nip U with respect to the sheet feeding direction. For that reason, in the case where a part or all of a broken heating belt 130 or a part or all of a broken pressing belt 120 is fed, the detecting sensor 140 can detect the broken belt. That is, the image forming apparatus in this embodiment is capable of detecting the broken belt in the case where there is a liability that the broken belt moves to the outside of the device. Specifically, in the case where the jammed sheet P or the broken belt presses the sensor flag 141 and thus the sensor flag 141 blocks detection light from the detecting sensor 140, the detecting sensor 140 is in an ON state. At this time, the detecting sensor 140 outputs an ON signal indicating that the object is present.

The sheet P passed through the fixing nip U is gradually fed toward a downstream portion of the image forming apparatus by a discharging roller pair 142 for the fixing device.

In this embodiment, the heating belt 130 is heated by an exciting coil 135 through electromagnetic induction heating. The CPU 10 controls a heater driver 135A on the basis of temperature information of the heating belt 130 detected by a temperature sensor (temperature detecting means) TH (FIG. 8). Then, the heater driver 135A adjusts electric power supplied to the exciting coil 135, so that a surface temperature of the heating belt 130 is temperature-adjusted at 180° C.±2° C.

Further, inside the tension roller 132, a heat pipe 136 for eliminating (canceling) a temperature difference of the tension roller 132 with respect to a longitudinal direction is provided. The heat pipe 136 performs a function of maintaining temperature uniformity of the heating belt 130 with respect to the belt widthwise direction in this embodiment, the heat pipe 136 is formed to have an outer diameter of about 16 mm and a width of about 350 mm. The heat pipe 136 may be appropriately selected from heat-resistant members.

In the case where the image forming apparatus 100 executes an operation in an image forming mode in which the image is formed on the sheet P, in the fixing device 114, as shown in FIG. 2, the fixing nip U is formed between the fixing belt 130 and the pressing belt 120 by causing these belts to press-contact each other. In this case, the fixing belt 130 and the pressing belt 120 are rotationally driven in arrow directions by the drive of the driving roller 131. Further, the fixing belt 130 is increased in temperature to a predetermined fixing temperature by an IH heater 135 and is temperature-controlled by the IH heater 135.

In this state, when the sheet P on which the unfixed toner image is carried is fed from the image forming portion 100A side into the fixing device 114, the fixing device 114 nips and feeds the sheet P in the fixing nip U.

The sheet P is, in a process in which the sheet P is nipped and fed through the fixing nip U, heated by heat of the fixing belt 130 and pressed at nip pressure. Then, the sheet P coming out of the fixing device 114 is fed and discharged onto the discharge tray 112 by the discharging roller pair 111 as described above.

### <Belt Breakage Detection Sequence>

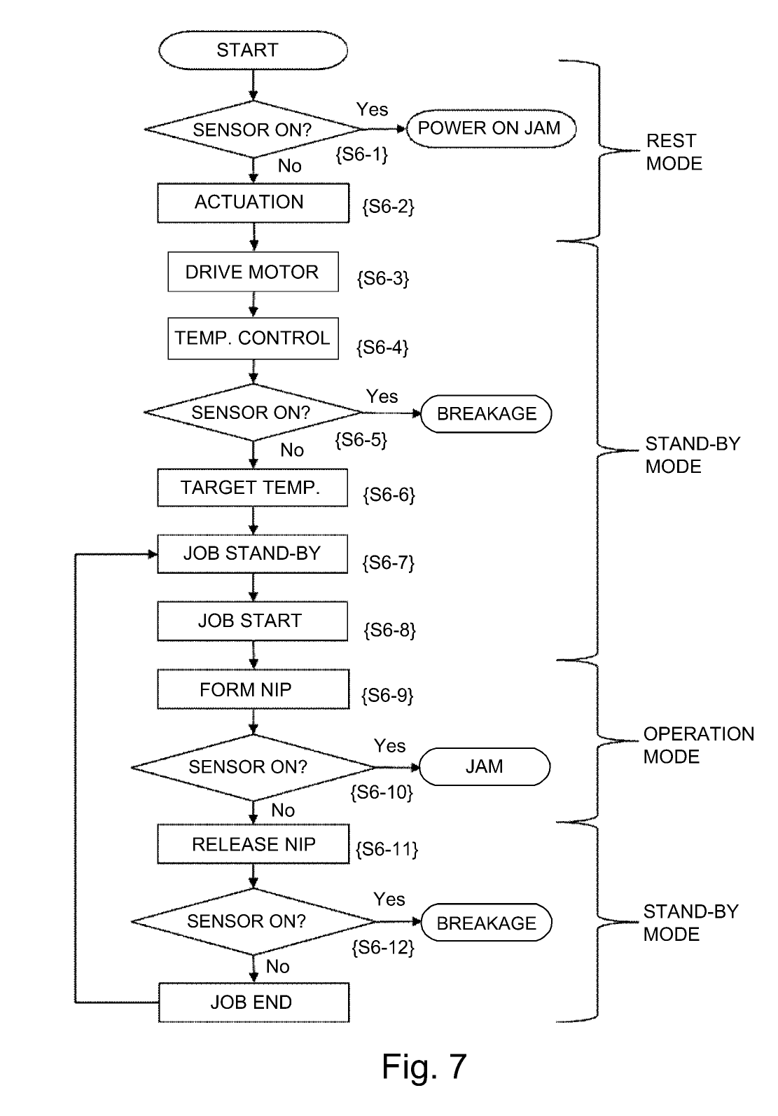

A belt breakage detection sequence of the image forming apparatus 100 in this embodiment will be described using a flowchart shown in FIG. 7 and a block diagram shown in FIG. 8.

When the main power source of the image forming apparatus 100 is turned on and the CPU 10 provides an energization instruction to respective constituent portions, the constituent portions of the image forming apparatus 100 go to an actuation control state. In the image forming apparatus 100 in this embodiment, before the sequence goes to the actuation control state (during OFF state of the main power source), the formation of the fixing nip U is eliminated and the drive of the driving motor 300 is at rest. In this embodiment, this state is referred to as a rest mode.

In general, immediately after the CPU 10 provides the energization instruction, there is no sheet P in the image forming apparatus 100. Accordingly, the detecting sensor 140 disposed immediately at the rear of the fixing nip U is in an OFF state (in which the detecting sensor 140 does not detect the sheet P).

However, in the case where the sheet P jammed in the fixing nip U and then the energization instruction is provided without performing the jam clearance, the detecting sensor 140 is in an ON state. In the case where the detecting sensor 140 is in the ON state during an operation in a rest mode, the CPU 10 prohibits the operation of the driving motor 300 and the IH heater 135 through the motor driver 300A and the heater driver 135A, respectively. That is, immediately after the rest mode, the sequence does not go to the actuation control.

Then, the CPU 10 notifies (displays) a message (power on jam) to the effect that the jammed sheet P should be removed (cleared) on the monitor 100C of the operating panel portion 100B through the display driver 100D <S6-1>. That is, the CPU 10 outputs, to the monitor 100C, a signal indicating that the sheet P jammed.

In the case where the detecting sensor 140 is in the OFF state in the operation in the rest mode, the sequence by the CPU 10 goes to the actuation control <S6-2>. Then, the CPU 10 drives the driving motor 300 <S6-3>, and operates the IH heater 135, thus starting temperature control <S6-4>. During execution of the actuation control by the CPU 10, the heating belt 130 and the pressing belt 120 are in a spaced state, so that the fixing nip U is not formed. However, the heating belt 130 and the pressing belt 120 are rotationally driven by the driving motor 300.

Then, the CPU 10 causes the heating belt 130 and the pressing belt 120 to be in stand-by in that state until a print job is inputted. In this embodiment, a state from start of the shift to the actuation control to the input of the print job is referred to as a stand-by mode. That is, in an operation in the stand-by mode, the CPU 10 is in stand-by for the input of the print job while spacing the fixing belt 130 and the pressing belt 120 and rotating the belt. During the actuation control, in general, the detecting sensor 140 is in the OFF state. Nevertheless, in the case where the detecting sensor 130 is placed in the ON state during the actuation control, the CPU 10 discriminates that the broken belt is fed on the feeding path. This is because in the case where the sheet P jams when the main power source of the image forming apparatus is turned on, the jam is detected during the operation in the rest mode. For that reason, until the jam clearance is made, the mode of the CPU 10 does not shift from the rest mode to the stand-by mode. Further, in the operation in the stand-by mode, the sheet P is not newly fed. That is, in the image forming apparatus 100, in the operation in the stand-by, the sheet P is absent on the feeding path. Therefore, the CPU 10 discriminates that the object detected downstream of the fixing nip is the broken belt. The broken belt may be any of the heating belt 130 and the pressing belt 120.

In the case where the detecting sensor 140 is in the ON state during the operation in the stand-by mode, the CPU 10 effects the following control. That is, the CPU 10 stops the driving motor 300 via the motor driver 300A, and stops the operation of the IH heater 135 via the heater driver 135A. The CPU 10 causes the monitor 100C to provide notification of prompting of exchange of the belt <S6-5>. That is, the CPU 10 outputs to the monitor 100C a signal indicating that the belt is broken (torn). Then, the mode of the CPU 10 shift from the stand-by mode to the rest mode.

When the CPU 10 confirms that the temperature of the heating belt 130 reaches a target temperature while keeping the detecting sensor 140 in the OFF state <S6-6>, the CPU 10 is in the stand-by state in which the CPU 10 waits for the print job <S6-7>. As shown in FIG. 7, the mode of the CPU 10 shifts to the operation mode after the stand-by mode. That is, the mode of the CPU 10 shifts to the operation mode (image forming mode) only from the stand-by mode.

When the print job is inputted into the CPU 10 during the operation in the stand-by mode, the CPU 10 executes the print job (operation in the image forming mode) on the basis of the print instruction <S6-8>. At this time, the fixing nip U is formed in accordance with the above-described operation <S6-9>. During the execution of the print job, the heating belt 130 and the pressing belt 120 are in the press-contact state and thus form the fixing nip U. Further, also the driving motor 300 is driven. In this embodiment, this state is referred to as the operation mode (image forming mode). That is, in the operation in the operation mode, not only the fixing belt 130 and the pressing belt 120 are contacted to each other but also the belt is rotated. During the print job, the detecting sensor 140 is turned on and off in synchronism with the passing of the sheet P. In the case where ON/OFF of the detecting sensor 140 is made in a predetermined period, the image forming apparatus is in a normal state, and therefore the CPU 10 does not effect particular control.

However, in the case where the sheet P jams in the fixing nip U during the operation in the operation mode, the sheet P is not normally fed, and therefore the detecting sensor 140 is continuously in the ON state for a predetermined time or more. Alternatively, when the heating belt 130 or the pressing belt 120 is broken, a part thereof is fed during the actuation, and similarly the detecting sensor 140 is in the ON state for the predetermined time or more.

In the case where the detecting sensor 140 is in the ON state for the predetermined time or more during the operation in the above-described operation mode, the CPU 10 stops the driving motor 300 through the motor driver 300A. Further, the CPU 10 stops the operation of the IH heater 135 through the heater driver 135A. Then, the CPU 10 causes the monitor 100C to display a message of the jam (generation) <S6-10>. That is, the CPU 10 outputs to the monitor 100C the signal indicating that the belt is broken. Then, the operation of the CPU 10 shifts from the operation in the operation mode to the operation in the rest mode.

The CPU 10 effects feeding output of the sheet P during the operation in the operation mode by using a detection result of the presence or absence of the sheet P. In the case where the detecting sensor 140 detects improper feeding of the sheet P, the CPU 10 stops the driving motor 300 via the motor driver 300A, and stops the IH heater 135 via the heater driver 135A. The CPU 10 causes the monitor 100C to provide notification of jam clearance of the sheet P <S6-5>. That is, the CPU 10 outputs a signal to the monitor 100C a signal indicating that the sheet P jams. Then, the operation of the CPU 10 shifts from the operation in the operation mode to the operation in the rest mode.

When the sequence reaches an ending condition of the print job without detecting abnormality by the detecting sensor 140, the CPU 10 releases the fixing nip U by the operation described above <S6-11>. At that time of the end of the print job, in general, the detecting sensor 140 is in the OFF state. At this timing, in the case where the detecting sensor 140 is in the ON state, the CPU 10 discriminates that the broken belt is fed. Then, the CPU 10 stops the driving motor 300 via the motor driver 300A, and stops the IH heater 134 via the heater driver 135A. Further, the CPU 10 causes the monitor 100C to provide notification of prompting of exchanges of the belt <S6-5>. That is, the CPU 10 outputs to the monitor 100C a signal indicating that the belt is broken. Then, the operation of the CPU 10 shifts from the operation in the stand-by mode to the operation in the rest mode. When the print job is end safely, the CPU 10 is in a stand-by state in which the CPU 10 waits for a subsequent print job <S6-7>.

As in this embodiment, when the detecting means disposed immediately at the rear of the fixing nip over the entire widthwise direction of the sheet feeding direction is used, even if a part of the belt is broken and disconnected, it is possible to detect the breakage of the belt. Even in the case where the belt is broken at any longitudinal position, it is possible to prevent the broken belt from moving to the outside of the device. Further, in the case where the detecting means is in the ON state in a period, other than the print job period, such as during the actuation control of the image forming apparatus or during the release of the nip of the fixing device, the notification of the breakage of the belt is provided (i.e., the signal for providing the notification of the breakage of the belt is outputted). As a result, it becomes possible to clearly notify the user of the belt breakage.

The constitution of the image forming apparatus including a belt breakage detecting constitution in this embodiment is summarized as follows. The image forming portion 100A for forming the toner image on the sheet P is provided. The heating belt 130 and the pressing belt 120, at least one of which is the endless belt, for forming the fixing nip U for permitting fixing of the toner image formed on the sheet P by the image forming portion 100A are provided. The detecting sensors 140 and 141, provided downstream of the fixing nip U with respect to the sheet feeding direction, for detecting the presence or absence of the sheet P are provided.

The CPU 10 shifted in mode to the stand-by mode in which the CPU 10 spaces the heating belt 130 and the pressing belt 120 from each other and is in stand-by while rotating the belt with the end of the image formation is provided. During the operation in the stand-by mode, in the case where the signal indicating the presence of the sheet P is inputted from the detecting sensors 140 and 141, the CPU 10 functioning as an output portion outputs to the monitor 100C the signal indicating the breakage of the belt. Then, the CPU 10 causes the monitor 100C, of the operation portion 100B, as a notifying portion to display a message of prompting of the exchange of the endless belt. That is, the monitor 100C notifies the operator of the prompting of the exchange of the belt. That is, the CPU 10 outputs the signal for notifying the operator of the prompting of the exchange of the endless belt.

That is, during the operation in the stand-by mode, in the case where the jam detecting sensors 140 and 141 disposed immediately at the rear of the fixing device are in the ON state, the image forming apparatus is in stand-by (i.e., during non-image formation (non-sheet passing)), and therefore the CPU 10 discriminates that the jam does not generate but the belt breakage generates. Then, the CPU 10 not only stops stand-by rotation (heating) of the belt but also provides notification of an error (prohibition of image formation) for prompting the operator (user) to exchange the belt. (In this case, on the operating portion, a message of “please call a service person” is displayed.)

In the case where in the operation in the image forming mode of the image forming apparatus 100 in which the sheet P is fed and the image forming operation is performed, the signal indicating the presence of the sheet P is continuously inputted from the detecting portions (detecting sensors) 140 and 141 for a predetermined time, the jam generates. In this case, the monitor (notifying portion) 100C provides the notification of prompting of the jam clearance upon receipt of the instruction from the CPU 10.

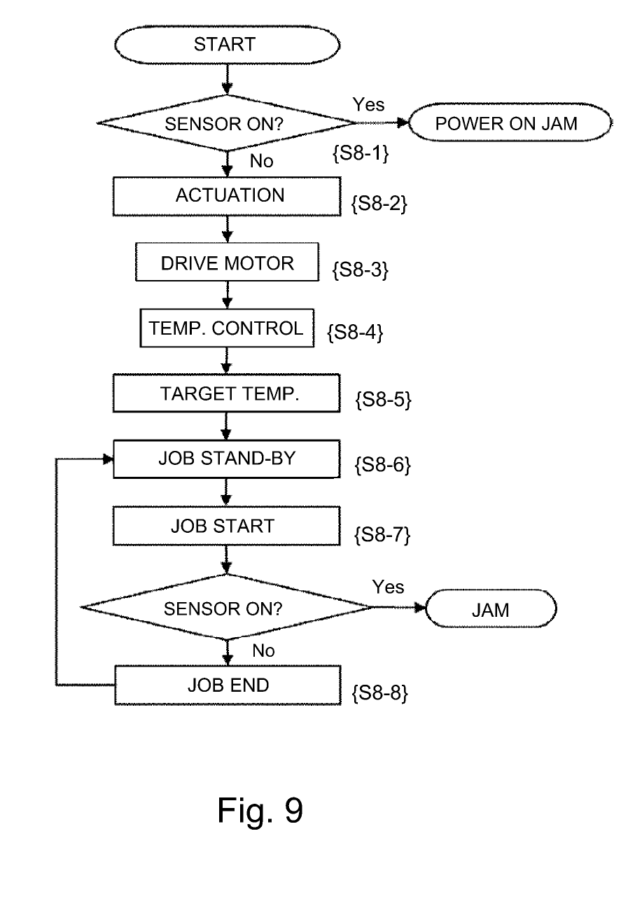

A belt breakage detecting sequence of an image forming apparatus in a conventional example will be described using a flowchart of FIG. 9. In the conventional example, an error exclusively for the belt breakage is not displayed but an error of the belt breakage is displayed collectively as an error of jam of the sheet P. A block diagram in the conventional example is similar to that in Embodiment 1, and therefore will be omitted.

When the energization instruction of the image forming apparatus is made by the CPU 10, the control shifts to the actuation control (rest mode). In general, immediately after the energization instruction, the image forming apparatus is in a state in which the sheet P is absence therein, and the detecting sensor 140 disposed immediately at the rear of the fixing nip U is in the OFF state.

However, in the case where the sheet P jams in the fixing nip U and then the energization instruction is made while jam clearance is not made, the detecting sensor 140 is in the ON state. Or, when the heating belt 130 or the pressing belt 120 is broken, a part thereof is fed during the actuation, and thus the detecting sensor 140 is similarly in the ON state. In the case where the detecting sensor 140 is turned on during the operation in the rest mode as in each of the above two cases, the CPU 10 stops the operation of the motor and the heater via the motor driver and the heater driver, respectively, and causes the monitor 100C to display power on jam <S8-1>.

The CPU 10 shifts to actuation control <S8-2>, and drives the motor <S8-3> and starts temperature control <S8-4>, and then the CPU 10 confirms that the temperature reaches the target temperature <S8-5>. Then, the CPU 10 is in the stand-by state in which the CPU 10 waits for the print job <S8-6>, and thereafter, the print job is started <S8-7>. During the print job, in general, the detecting sensor 140 is in the OFF state.

However, in the case where the sheet P jams in the fixing nip U, the detecting sensor 140 is in the ON state. Or, when the heating belt 130 or the pressing belt 120 is broken, a part thereof is fed during the actuation, and thus the detecting sensor 140 is similarly in the ON state. In the above two cases, the CPU 10 stops the operation of the motor and the heater via the motor driver and the heater driver, respectively, and causes the monitor 100C to display power on jam <S8-8>.

As described above, in this embodiment, the belt breakage detection is made using the detecting means 140 and 141 disposed immediately at the rear of the fixing nip over the entire longitudinal region, and thus even in the case where the belt is broken at any position, it becomes possible to prevent the broken belt from moving to the outside of the device.

Further, also in the case where the detecting means is turned on in a period, other than the print job period, such as during the actuation control of the image forming apparatus or during release of the fixing nip of the fixing device, an error is displayed, so that it is possible to early find out the belt breakage.

### OTHER EMBODIMENTS

(1) As the fixing device, the device for heating the unfixed toner image formed on the sheet was described as an example, but a device for increasing a glossiness of the image by re-heating the toner image temporarily fixed or fixed on the sheet may also be used. Also in this case, the device is referred to as the fixing device.

(2) Embodiment 1 was described using the fixing device in which both of the fixing member and the pressing member are the endless belt, but the present invention is not limited to this device constitution. Such a device constitution that either one of the fixing member and the pressing member is the endless belt and the other member is a roller may also be employed.

(3) The notification of the belt exchange may also be made in such a manner that the message of the belt exchange is displayed on a monitor attached to the host device 200, such as the PC or the like, connected with the image forming apparatus through the network.

(4) The image forming portion 100A of the image forming apparatus 100 is not limited to that of the electrophotographic type. Image forming apparatuses for forming the unfixed toner images on the sheets P by using other known transfer-type or direct-type image forming principles or types such as an electrostatic recording type and a magnetic recording type may also be used.

(5) The image forming apparatus is not limited to the monochromatic (single-color) image forming apparatus for forming a monochromatic image or the like, in which a single image bearing member (photosensitive drum or the like) is provided, but may also be a color image forming apparatus.

(6) The heating means for the belt and the roller which form the fixing nip is not limited to the electromagnetic induction heating means. The heating means can also have a device constitution employing proper heating means or heating type, such as a halogen heater, a ceramic heater or an infrared lamp, which heat the belt or the roller from an inside or an outside.

(7) The position of the detecting sensors 140 and 141 is not limited to the entire longitudinal region. The detecting sensors 140 and 141 may also be provided at a widthwise end portion, of the feeding path, corresponding to the belt end portion where the belt breakage is liable to generate or at a widthwise central portion where detection of the passing of the sheet can be easily mode. In such a constitution, a sufficient effect of detecting the generation of the belt breakage is obtained. A further improved effect is obtained by disposing the detecting sensors 140 and 141 so as to cover a non-detection range of another belt breakage detecting means.

(8) The stand-by mode is not limited to during the temperature control or the print job stand-by state. The stand-by mode is only required to be a state in which the endless belt rotates and the nip is released. For example, the stand-by mode is also applicable to the case where a non-sheet-passing state is confirmed by the CPU 10 during the print job such as switching of the feeding portion in the feeding device including a plurality of feeding portions. It is also assumed that the stand-by is a state in which the image forming apparatus waits for image adjustment during the print job or a process in a post-processing device. That is, in the case where the sheet is not passed for a predetermined time or more, the state in which the fixing nip is released corresponds to the stand-by mode.

While the invention has been described with reference to the structures disclosed herein, it is not confined to the details set forth and this application is intended to cover such modifications or changes as may come within the purpose of the improvements or the scope of the following claims.

This application claims the benefit of Japanese Patent Application No. 2014-105181 filed on May 21, 2014, which is hereby incorporated by reference herein in its entirety.

What is claimed is:

1. An image forming apparatus comprising:
an image forming portion configured to form a toner image on a sheet;
a pair of rotatable members configured to form a fixing nip for fixing the toner image, formed by said image forming potion, on the sheet, at least one of said pair of rotatable members being an endless belt;
a contact-and-separation portion configured to move said pair of rotatable members toward and away from each other;
a driving portion configured to rotationally drive said belt;
a detecting portion configured to detect presence or absence of the sheet and another object on a sheet feeding path downstream of the fixing nip with respect to a sheet feeding direction; and
an output portion configured to output a signal indicating breakage of said belt upon detection of the presence of the object on the sheet feeding path by said detecting portion when said rotatable members are spaced from each other and said belt rotates.

2. An image forming apparatus according to claim 1, further comprising a notifying portion configured to provide notification of prompting of exchange of said belt on the basis of the signal.

3. An image forming apparatus according to claim 1, wherein said driving portion stops rotation of said belt upon detection of presence of the object by said detecting portion when said pair of rotatable members are spaced from each other and said belt rotates.

4. An image forming apparatus according to claim 1, wherein said output portion outputs a signal indicating generation of a jam upon continuous detection of presence of the sheet for a predetermined time by said detecting portion when said pair of rotatable members effects fixing.

5. An image forming apparatus according to claim 1, wherein said output portion outputs a signal indicating generation of a jam upon detection of presence of the sheet by said detecting portion when a main power source of said image forming apparatus is turned on.

6. An image forming apparatus comprising:
an image forming portion configured to form a toner image on a sheet;
a pair of rotatable members configured to form a fixing nip for fixing the toner image, formed by said image forming potion, on the sheet, at least one of said pair of rotatable members being an endless belt;
a contact-and-separation portion configured to move said pair of rotatable members toward and away from each other;
a driving portion configured to rotationally drive said belt;
a detecting portion configured to detect presence or absence of the sheet and another object on a sheet feeding path downstream of the fixing nip with respect to a sheet feeding direction; and
an output portion configured to output a signal indicating breakage of said belt upon detection of a change from an absence state to a presence state of the object on the sheet feeding path by said detecting portion when the sheet is not fed in said image forming apparatus and said belt rotates.

7. An image forming apparatus according to claim 6, wherein during stand-by of an image forming job, said contact-and-separation portion moves said pair of rotatable members toward and away from each other, and said driving portion rotationally drives said belt.

8. An image forming apparatus according to claim 6, further comprising a notifying portion configured to provide notification of prompting of exchange of said belt on the basis of the signal.

9. An image forming apparatus according to claim 6, wherein said driving portion stops rotation of said belt upon detection of presence of the object by said detecting portion when said pair of rotatable members are spaced from each other and said belt rotates.

10. An image forming apparatus according to claim 6, wherein said output portion outputs a signal indicating generation of a jam upon continuous detection of presence of the sheet for a predetermined time by said detecting portion when said pair of rotatable members effects fixing.

11. An image forming apparatus according to claim 6, wherein said output portion outputs a signal indicating generation of a jam upon detection of presence of the sheet by said detecting portion when a main power source of said image forming apparatus is turned on.
